(19) United States
(12) Patent Application Publication
(10) Pub. No.: US 2005/0204936 A1
(43) Pub. Date: Sep. 22, 2005

(54) Food cutting apparatus

(76) Inventor: Carlo Rosa, Lecco (IT)

Correspondence Address: STITES & HARBISON PLLC, 1199 NORTH FAIRFAX STREET, SUITE 900, ALEXANDRIA, VA, 22314, US

(21) Appl. No.: 10/518,853

(22) PCT Filed: Jul. 3, 2003
(86) PCT No.: PCT/EP03/07118

§ 371 Date: Dec. 22, 2004

(30) Foreign Application Priority Data
Jul. 24, 2002 (IT) GE2002A000066

(51) Int. Cl. A47J 17/00

(52) U.S. Cl. 99/537

(57) ABSTRACT

Food cutting apparatus comprising a main body (1) 5 provided with drive means (2) connected, by suitable transmission components (3, 4, 5, 6), to a rotating tool (9) comprising a housing (8) of essentially cylindrical shape in front of a loading mouth (12) for the food (27) that is to be cut and provided with at least one main blade (10) that projects radially from the outer surface of this housing (8); this apparatus comprises a cutting device (14) connected to this main body (1) and inserted into this housing (8) of the tool (9); this device (14) is provided with cutting means (22, 30) working with this main blade (10) of the rotating tool (9) to give the cut food (27) any shape such as sticks, dice or other shapes.

### DESCRIPTION

The present invention relates to a food cutting apparatus, particularly for cutting loose food such as vegetables, fruit, cheese or the like.

As is known, there are in existence apparatuses for cutting food into slices, consisting of a main body housing an electric motor connected, by suitable transmission components, to a tool rotating in front of a loading mouth for the food to be cut, comprising a cylindrical housing provided with a main blade projecting radially from the outer surface of the said housing. With this main blade it is possible to cut food into slices, while by adding to the said cylindrical housing a series of cutters in front of the said blade, it is possible to cut the food into sticks.

Among the major drawbacks of these apparatuses is the fact that it is impossible to cut food into shapes other than sticks or slices, so the object of the present invention is to provide an apparatus capable of cutting food into other shapes as well, such as dice or the like, and that will significantly increase the efficiency of stick cutting, by combining the rotating tool with a stationary and interchangeable device.

This object is achieved by the present invention in the form of a food cutting apparatus comprising a main body provided with drive means connected, by suitable transmission components, to a rotating tool comprising a housing of essentially cylindrical shape in front of a loading mouth for the food that is to be cut and provided with at least one main blade that projects radially from the outer surface of the said housing; this apparatus comprises a cutting device connected removably to a seat provided in the main body of the apparatus and inserted into this housing of the tool; this device is provided with cutting means working with this main blade of the tool to give the cut food any shape such as sticks, dice or other shapes.

Other objects and advantages of the present invention will be understood more fully on perusing the following description, taken by way of non-restrictive example, with reference to the appended drawings in which:

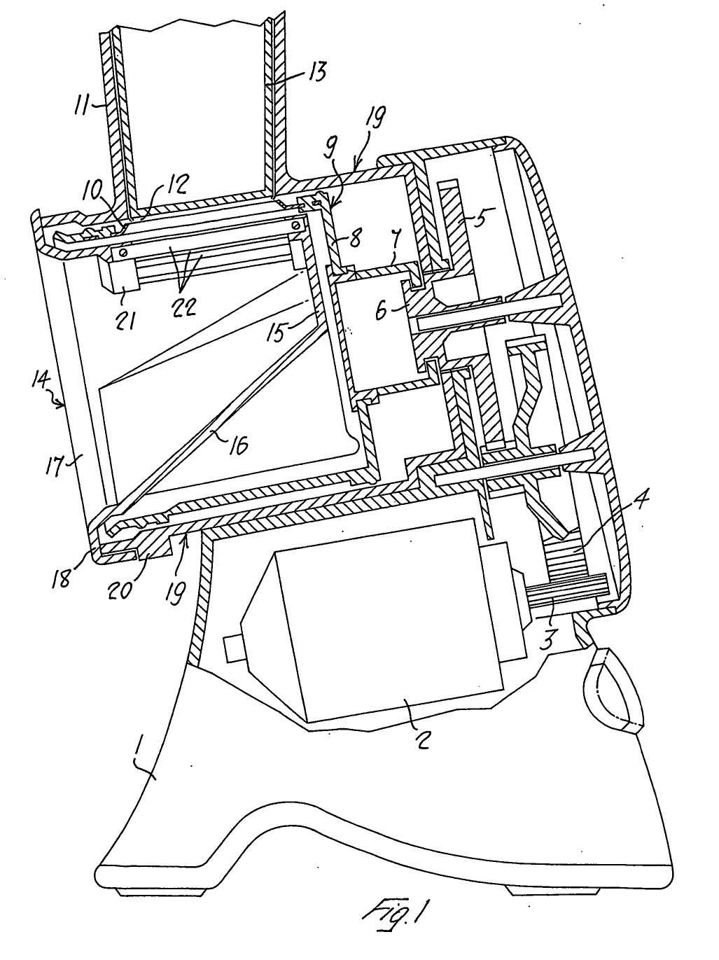

FIG. 1 is a side view, partly in section, of a food cutting apparatus according to the present invention;

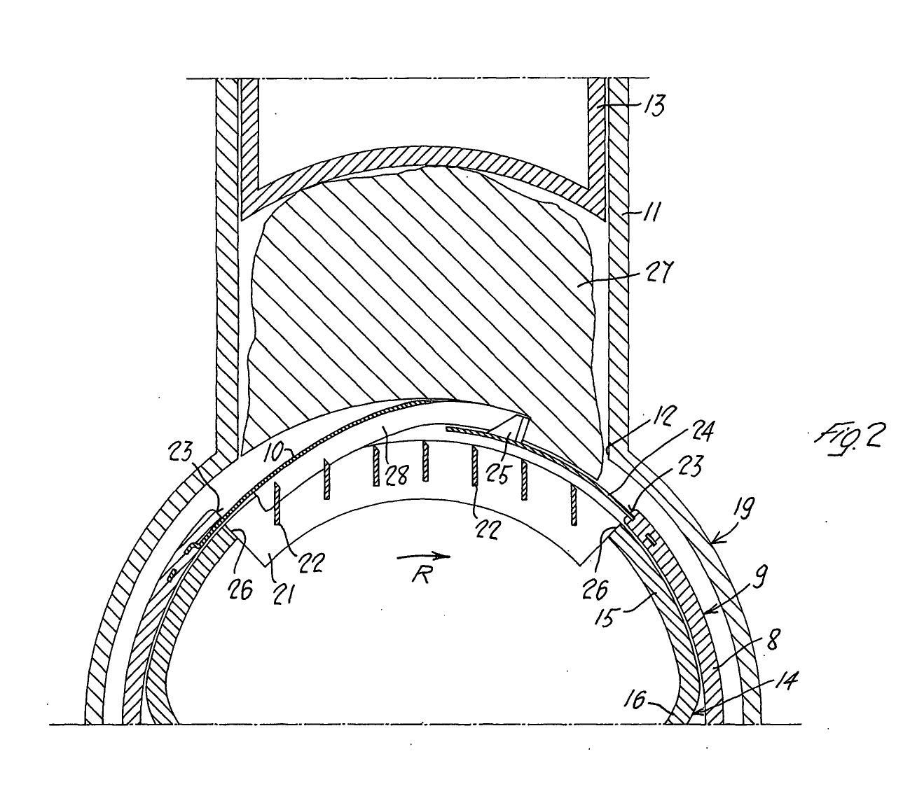

FIG. 2 is a partial front view in cross section of a first embodiment of a food dicing device inserted into the apparatus shown in FIG. 1 and illustrated at an intermediate stage of operation;

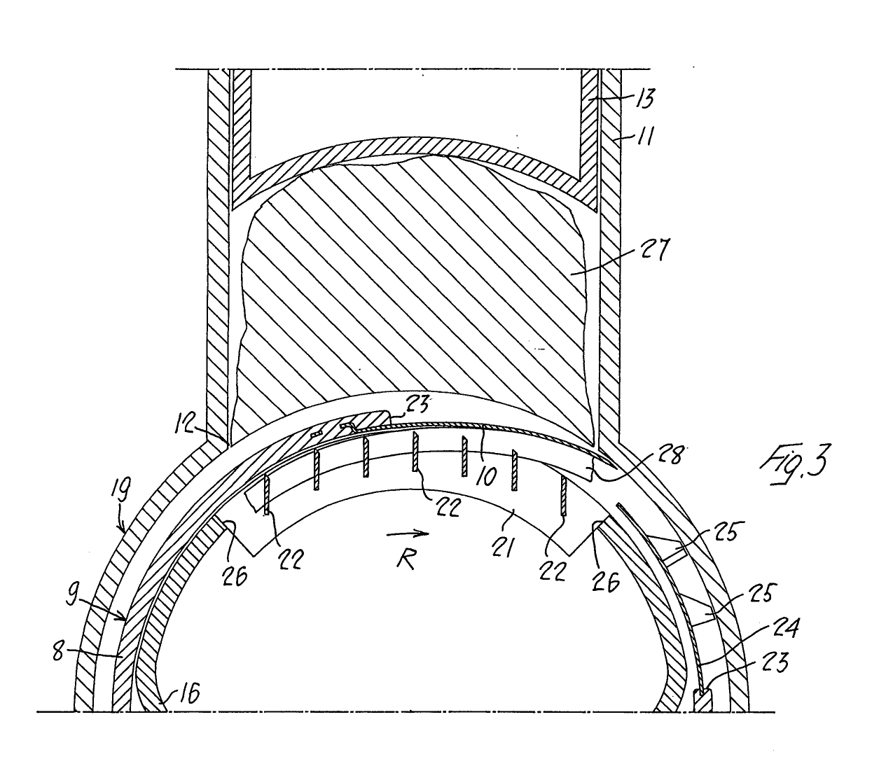

FIG. 3 is a partial front view in cross section of the device shown in FIG. 2 at a later stage of operation;

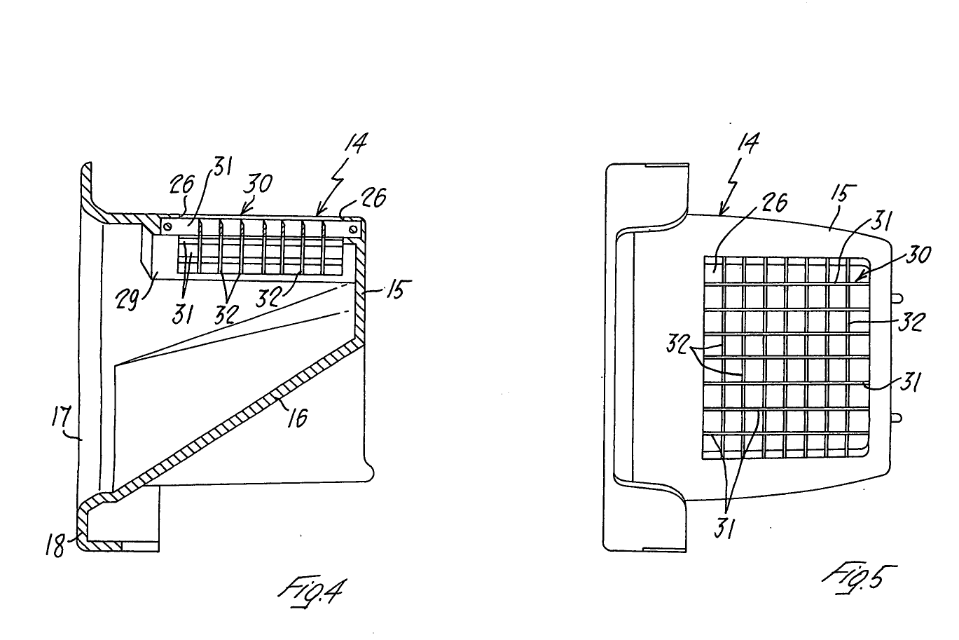

FIG. 4 is a side view, partly in section, of a second embodiment of the food dicing device; and

FIG. 5 is, a top plan view of the dicing device shown in FIG. 4.

Referring to the appended drawings and in particular to FIG. 1 of these, shown at 1 is the main body of a food cutting apparatus. Housed inside this main body 1 is an electric motor 2 comprising a main shaft 3 connected by a pair of transmission gears 4, 5 to a hub 6, to which is fixed, by a bayonet attachment 7, the cylindrical housing 8 of a rotating tool 9. This rotating tool 9 is positioned inside a stationary seat 19 located above the main body 1 of the apparatus and comprising a main metal blade 10 fixed to the housing 8. This main blade 10 projects radially from the cylindrical surface of the said housing 8, as shown in FIG. 2. Above the rotating tool 9 and the stationary seat 19 is a hopper 11 for loading the food to be cut, which is pushed and pressed towards a loading mouth 12 by a pressing block 113. Another, stationary cutting device 14 is inserted inside the housing 8 of this rotating tool 9 and comprises at the top an essentially cylindrical body 15 and at the bottom an inclined sliding surface 16 for the cut food leading towards a discharge mouth 17. At the lower end of the said inclined surface 16, the cutting device 14 comprises a part 18 designed to clip onto a projecting edge 20 of the stationary seat 19 located above the main body 1. As can be seen again in FIG. 1, the upper cylindrical body 15 of the said cutting device 14 comprises an arcuate support 21 to which are fixed a series of essentially vertical blades 22.

FIG. 2 is a front view of the cutting device 14 fitted inside the cylindrical housing 8 of the rotating tool 9. This housing 8 includes an upper opening 23 to whose edges there are fixed on the one hand, on the left when viewing the figure, the radially projecting main blade 10 and, on the other hand, on the right when viewing the figure, a support plate 24 for a series of cutters 25 arranged essentially in a direction that is perpendicular to the surface of the cylindrical housing 8 and in front of the main blade 10, with reference to the direction of rotation of the tool 9 indicated in the figure by the arrow R. If the housing 8 is made of plastic by injection moulding, this main blade 10 and this support plate 24 may be inserted into the said housing 8 during moulding. Otherwise, they may be fitted at a later stage. As an alternative to this, furthermore, it would be possible to have several main blades 10 arranged around the cylindrical housing 8 at regular intervals, e.g. two diametrically opposite blades 10 at 180° from each other. Fitted inside the said housing 8 are the upper cylindrical body 15 and the lower inclined surface 16 of the cutting device: this cylindrical body 15 comprises an upper opening 26 to which is fixed the support for the blades 22, the latter being arranged in an essentially vertical direction, that is parallel to the axis of rotation of the tool 9 and perpendicular to the cutters 25. These blades 22 are in front of the loading mouth 12 at the bottom end of the hopper 11, into which the food 27 to be cut is inserted and pushed against the rotating tool 9 by the pressing block 13.

FIGS. 2 and 3 show two successive stages in the operation of the present apparatus: when the tool 9 is turned by the electric motor 2 the cutters 25 initially cut into the bottom of the food 27 and the main blade 10 then cuts the said food 27 into a series of sticks 28, one of which can be seen in the figure. Note that these cutters may all be arranged along the same directrix of the cylindrical housing 8 and hence of the associated support plate 24, or may be offset from each other, as shown in FIG. 3. During the rotation R, the main blade 10 forces the sticks 28 down onto the blades 22 of the cutting device, which is in a stationary position, with the result that the sticks 28 are additionally cut at right angles to their length, thus giving dice which pass through the support 21 of the said blades 22 and slide down the lower inclined surface 16 to the discharge mouth 17, shown in FIG. 1.

If the rotating tool 9 does not have the cutters 25 preceding the main blade 10, the present apparatus can still be used to efficiently cut the food 27 into sticks: in this situation, as it rotates, the said main blade 10 will cut the said food 27 into slices which will be pushed against the blades 22 of the stationary device 14, thus producing sticks which will fall towards the discharge mouth 17 down the inclined surface 16.

FIGS. 4 and 5 show an alternative embodiment of the cutting device 14 of the present apparatus. In this variant the said device 14 comprises on the upper opening 26 of the cylindrical body 15 a support 29 for a grid 30 composed of a first series of blades 31, similar to the blades 22 seen earlier and therefore positioned in a direction that is essentially parallel to the axis of rotation R of the tool 9, and a second series of blades 32 arranged perpendicularly to the said first series of blades 31, as shown in FIG. 4. The operation of the apparatus with this alternative embodiment is exactly the same as described earlier in respect of FIGS. 2 and 3, except that the rotating tool 9 does not have the cutters 25 preceding the main blade 10: in this case, as it rotates, the main blade 10 will simply cut slices of food 27 which will be forced down onto the grid 30, directly producing dice because of the arrangement of the series of blades 31 and 32.

The above description has explained, for illustrative, non-restrictive purposes, various situations in which a stationary device 14 works with a rotating tool 9 to cut food 27 into sticks or dice. It should be emphasized that it would of course be possible to cut food to any other shape and size, e.g. by varying the shape of the grid 30 illustrated in FIGS. 4 and 5 and leaving the principles of operation of the present device as described unchanged.

1. Food cutting apparatus comprising a main body (1) provided with drive means (2) connected, by suitable transmission components (3, 4, 5, 6), to a rotating tool (9) comprising a housing (8) of essentially cylindrical shape in front of a loading mouth (12) for the food (27) that is to be cut and provided with at least one main blade (10) that projects radially from the outer surface of the said housing (8), which apparatus is characterized in that it comprises a cutting device (14) connected to the said main body (1) and inserted into the said housing (8) of the tool (9), the said device (14) being provided with cutting means (22, 30) working with the said main blade (10) of the rotating tool (9) to give the cut food (27) any shape such as sticks, dice or other shapes.

2. Apparatus according to claim 1, characterized in that the said device (14) comprises an opening (26) in front of the mouth (12) through which the food (27) to be cut is loaded, the said cutting means (22, 30) being fixed to the said opening (26) and the said main blade (10) being capable of pushing the said food (27) against the said cutting means (22, 30).

3. Apparatus according to claim 1, characterized in that the said cutting device (14) is in a stationary position and comprises a series of blades (22) fixed to its outer surface, the said blades (22) being positioned in a direction that is essentially parallel to the axis of rotation (R) of the rotating tool (9).

4. Apparatus according to claim 1, characterized in that the said device (14) comprises a grid (30) composed of a first series of blades (31) positioned in a direction that is essentially parallel to the axis of rotation (R) of the tool (9) and a second series of blades (32) arranged in a direction that is essentially perpendicular to the said first series of blades (31).

5. Apparatus according to claim 3, characterized in that the rotating tool (9) comprises a series of cutters (25) arranged in front of the main blade (10) and essentially in a direction that is perpendicular to the cylindrical housing (8) of the said tool (9), the said cutters (25) and the said main blade (10) working with the said series of blades (22) of the device (14).

6. Apparatus according to any one of the preceding claims, characterized in that the said cutting device (14) comprises an essentially cylindrical upper body (15) inserted into the housing (8) of the said rotating tool (9) and fixed removably to a seat (19) provided in the main body (1) of the apparatus.

7. Apparatus according to any one of the preceding claims, characterized in that the said device (14) comprises a lower inclined sliding surface (16) for the food (27), having a discharge mouth (17) for the said food (27) at its end.

8. Apparatus according to claim 6, characterized in that the said device (14) comprises a part (18) designed to clip onto a projecting edge (20) of the said stationary seat (19) provided in the main body (1) of the apparatus.
